(19) United States
(12) Patent Application Publication
(10) Pub. No.: US 2026/0358667 A1
(43) Pub. Date: Nov. 12, 2026

(54) SEE-THROUGH DISPLAY DEVICE

(71) Applicant: Liqxtal Technology Inc., Tainan City (TW)

(72) Inventors: Hung-Shan CHEN, Tainan City (TW); Sung-Nan CHEN, Tainan City (TW); Chia-Ming CHANG, Tainan City (TW); Chien-Chung CHEN, Tainan City (TW)

(21) Appl. No.: 19/203,132

(22) Filed: May 8, 2025

(51) Int. Cl. G02F 1/16766; G02F 1/1335; G02F 1/167; G02F 1/1677

(52) U.S. Cl. CPC G02F 1/16766; G02F 1/133502; G02F 1/167; G02F 1/1677; G02F 2203/01

(57) ABSTRACT

A see-through display device has a transparent region and a display region surrounding the transparent region. The see-through display device includes a first substrate coated with a plurality of pixelated electrodes; a second substrate coated with a counter electrode; a display medium layer between the first substrate and the second substrate, wherein the display medium layer in the transparent region is transparent; and an electrical controller electrically connected to the first substrate and the second substrate to provide signals to the pixelated electrode and the counter electrode.

### BACKGROUND

### Field of Invention

The present disclosure relates to a see-through display device.

### Description of Related Art

Electronic paper (“e-paper”) is a display technology designed to recreate the appearance of ink on ordinary paper. E-paper reflects light like ordinary paper and may be capable of displaying text and images indefinitely without using electricity to refresh the image, while allowing the image to be changed later. E-paper implementations include an e-paper display and electronics for rendering and displaying digital media on the e-paper, such as electronic books (“e-books”).

### SUMMARY

According to some embodiments of the present disclosure, a see-through display device has a transparent region and a display region surrounding the transparent region. The see-through display device includes a first substrate coated with a plurality of pixelated electrodes; a second substrate coated with a counter electrode; a display medium layer between the first substrate and the second substrate, wherein the display medium layer in the transparent region is transparent; and an electrical controller electrically connected to the first substrate and the second substrate to provide signals to the pixelated electrode and the counter electrode.

In some embodiments, the display medium layer includes a plurality of display mediums in the display region, each of the plurality of display mediums includes an electrophoretic liquid and a plurality of charged particles distributed in the electrophoretic liquid, and the transparent region of the see-through display device is free of the charged particles.

In some embodiments, the display medium layer includes a cholesteric liquid crystal material, and the transparent region of the see-through display device is free of the cholesteric liquid crystal material.

In some embodiments, the display medium layer has an opening in the transparent region of the see-through display device.

In some embodiments, the first substrate has a first opening in the transparent region of the see-through display device, and the second substrate has a second opening in the transparent region of the see-through display device.

In some embodiments, the display medium layer has a transparent material in the transparent region of the see-through display device.

In some embodiments, the see-through display device includes a plurality of active devices over the first substrate and electrically connected with the pixelated electrodes; a plurality of data lines over the first substrate and electrically connected with terminals of the active devices; and a plurality of gate lines over the first substrate and electrically connected with control terminals of the active devices, wherein the transparent region of the see-through display device is free of the data lines and the gate lines.

In some embodiments, the see-through display device further includes a plurality of active devices over the first substrate and electrically connected with the pixelated electrodes and a plurality of data lines over the first substrate and electrically connected with terminals of the active devices, wherein a shape of the data lines in the transparent region of the see-through display device is different from a shape of the data lines in the display region of the see-through display device.

In some embodiments, the see-through display device further includes a plurality of gate lines over the first substrate and electrically connected with control terminals of the active devices, wherein a shape of the gate lines in the transparent region of the see-through display device is different from a shape of the gate lines in the display region of the see-through display device.

In some embodiments, the see-through display device further includes a light absorbing layer, wherein the first substrate is between the light absorbing layer and the display medium layer; and a front-end light module, wherein the second substrate is between the front-end light module and the display medium layer.

In some embodiments, the see-through display device further includes a backside protective layer, wherein the first substrate is between the backside protective layer and the display medium layer; and a frontside protective layer, wherein the second substrate is between the frontside protective layer and the display medium layer.

In some embodiments, the backside protective layer includes an anti-reflection film having a reflectance less than 15%.

According to some embodiments of the present disclosure, the see-through display device has a transparent region and a display region surrounding the transparent region. The see-through display device includes an active device array substrate, a second substrate, and a display medium layer between the active device array substrate and the second substrate. The active device array substrate includes a first substrate; a plurality of pixelated electrodes over the first substrate; a plurality of active devices over the first substrate and electrically connected with the pixelated electrodes; and a plurality of data lines over the first substrate and electrically connected with terminals of the active devices, wherein a shape of the data lines in the transparent region of the see-through display device is different from a shape of the data lines in the display region of the see-through display device. The second substrate coated with a counter electrode. The display medium layer is between the active device array substrate and the second substrate.

In some embodiments, the display medium layer includes a plurality of display mediums in the display region, each of the plurality of display mediums includes an electrophoretic liquid and a plurality of charged particles distributed in the electrophoretic liquid, and the transparent region of the see-through display device is free of the charged particles.

In some embodiments, the display medium layer includes a cholesteric liquid crystal material, and the transparent region of the see-through display device is free of the cholesteric liquid crystal material.

In some embodiments, the active device array substrate further includes a plurality of gate lines over the first substrate and electrically connected with control terminals of the active devices, wherein a shape of the gate lines in the transparent region of the see-through display device is different from a shape of the gate lines in the display region of the see-through display device.

In some embodiments, the shape of the data lines in the transparent region of the see-through display device is a sawtooth shape.

Based on the above description, a see-through display device is designed with transparent regions, such that a user at the backside of the see-through display device may see the scene on a frontside of the see-through display device through the transparent regions. And, the observer at the frontside of the see-through display device may perceive the image displayed by the see-through display device.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows.

FIG. 1 is a schematic cross-sectional view of a see-through display device according to some embodiment of the disclosure.

FIGS. 2-5 are schematic front-side views of see-through display devices according to some embodiment of the disclosure.

FIG. 6A is a schematic cross-sectional view of a see-through display device according to some embodiment of the disclosure.

FIG. 6B is a schematic cross-sectional view of a see-through display device according to some embodiment of the disclosure.

FIG. 7A is a schematic cross-sectional view illustrating an example of a see-through display device according to some embodiment of the disclosure.

FIG. 7B is a schematic cross-sectional view illustrating an example of a see-through display device according to some embodiment of the disclosure.

FIG. 8A is a schematic cross-sectional view illustrating an example of a see-through display device according to some embodiment of the disclosure.

FIG. 8B is a schematic cross-sectional view illustrating an example of a see-through display device according to some embodiment of the disclosure.

FIG. 9A is a schematic top view of an active device array substrate of a see-through display device according to some embodiment of the disclosure.

FIG. 9B is an enlarged view of a portion of the active device array substrate of FIG. 9A.

FIG. 10A is a schematic top view of an active device array substrate of a see-through display device according to some embodiment of the disclosure.

FIG. 10B is an enlarged view of a portion of the active device array substrate of FIG. 10A.

FIG. 11A is a schematic top view of an active device array substrate of a see-through display device according to some embodiment of the disclosure.

FIG. 11B is an enlarged view of a portion of the active device array substrate of FIG. 11A.

FIG. 12A is a schematic top view of an active device array substrate of a see-through display device according to some embodiment of the disclosure.

FIG. 12B is an enlarged view of a portion of the active device array substrate of FIG. 12A.

FIGS. 13-16 respectively show schematic top views of black matrixes of see-through display devices according to some embodiment of the disclosure.

FIG. 17 is a front-side view of an exemplary see-through display device according to some embodiment of the disclosure.

FIG. 18 is a schematic cross-sectional view of the see-through display device of FIG. 17.

FIGS. 19A and 19B are lateral-side views of an exemplary see-through display device according to some embodiment of the disclosure.

FIG. 20 is a lateral-side view of an exemplary see-through display device according to some embodiment of the disclosure.

FIG. 21 is a lateral-side view of an exemplary see-through display device according to some embodiment of the disclosure.

FIG. 22 is a lateral-side view of an exemplary see-through display device according to some embodiment of the disclosure.

FIG. 23 is a lateral-side view of an exemplary see-through display device according to some embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

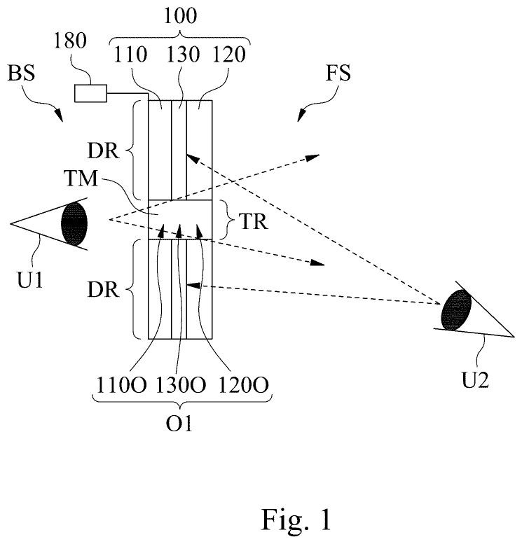

FIG. 1 is a schematic cross-sectional view of a see-through display device 100 according to some embodiment of the disclosure. The see-through display device 100 has a transparent region TR and a display region DR surrounding the transparent region TR. The see-through display device 100 includes a first substrate 110, a second substrate 120, a display medium layer 130 between the first substrate 110 and the second substrate 120, and an electrical controller 180 electrically connected to the first substrate 110 and the second substrate 120. The first substrate 110 may be an active device array substrate, which has a transparent substrate coated with pixelated electrodes. The first substrate 110 may include thin-film transistors (TFT) and may include reflective layers. The first substrate 110 may include thin-film transistors (TFT) and corresponding circuits, and the second substrate 120 may include reflective layers. The second substrate 120 be a transparent substrate coated with a counter electrode. The second substrate 120 may include a black matrix, one or more anti-reflection films, and one or more scattering films.

In some embodiments, the display medium layer 130 may be an electronic paper (“e-paper”). For example, the display medium layer 130 may include electrophoretic display mediums or a cholesteric liquid crystal material, which has no self-luminous ability. In some embodiments of the present disclosure, the display medium layer 130 in the transparent region TR is transparent. For example, the transparent region TR is free from the electrophoretic display mediums or the cholesteric liquid crystal material of the display medium layer 130. For another example, the display medium layer 130 in the transparent region TR is transparent in part of the visible spectrum, and is opaque in other part of the spectrum, including invisible spectrum. The displayed image is in the opaque spectrum range. The electrical controller 180 provides signals to the pixelated electrodes and the counter electrode. For example, the electrical controller 180 provides signals to the pixelated electrodes through thin-film transistors (TFT) and corresponding circuits, and provides signals to the counter electrode through conductive elements between the first substrate and the second substrate, such as Au balls.

In the illustrated embodiments, the first substrate 110, the second substrate 120, and the display medium layer 130 may have openings 110O, 120O, 130O communicated with each other in the transparent region TR of the see-through display device 100. The openings 110O, 120O, 130O in combination may be referred to as an opening O1 in the context. The openings 110O, 120O, 130O may be optionally filled with a transparent material TM. Thus, the user U1 at a backside BS of the see-through display device 100 may see the scene on a frontside FS of the see-through display device 100 through the opening O1 (and the transparent material TM). And, the observer U2 at the frontside FS of the see-through display device 100 may perceive the image displayed by the see-through display device 100.

In some alternative embodiments of the present disclosure, the see-through display device 100 may have intact transparent materials in the transparent region TR, rather than having the opening O1 extending through the first substrate 110, the second substrate 120, and the display medium layer 130. In the embodiments where the display medium layer 130 has electrophoretic display mediums, the transparent region TR may be free of the electrophoretic display mediums. In the embodiments where the display medium layer 130 has the cholesteric liquid crystal material, the transparent region TR may be free of the cholesteric liquid crystal material.

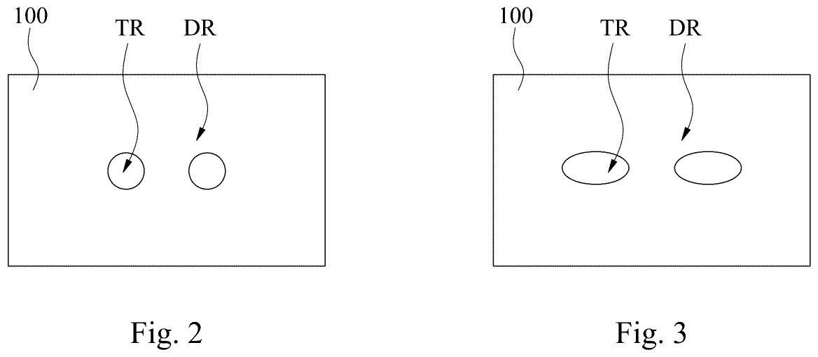

FIGS. 2-5 are schematic front-side views of see-through display devices 100 according to some embodiment of the disclosure. The transparent regions TR of the see-through display devices 100 may have various shapes. For example, in FIG. 2, the transparent region TR has a circular shape. In some other examples, the transparent region TR may have rectangular shape, triangular shape, the like, or the combination thereof.

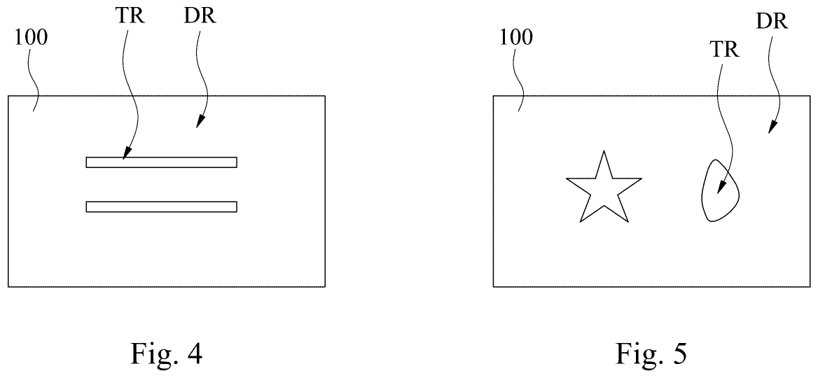

In some embodiments, the transparent region TR has a lengthwise direction substantially parallel with a lengthwise direction of the see-through display device 100. For example, in FIG. 3, the transparent region TR has an oval shape, and the oval shape of the transparent region TR has a long axis substantially parallel with the lengthwise direction of the see-through display device 100. And, in FIG. 4, the transparent region TR has a rectangular shape, and the rectangular shape of the transparent region TR has a lengthwise axis substantially parallel with the lengthwise direction of the see-through display device 100.

In some embodiments, the plural transparent regions TR of one see-through display device 100 may have a same shape, as shown in FIGS. 2-4. In some other embodiments, the transparent regions TR of one see-through display device 100 may have different shapes. For example, in FIG. 5, one of the transparent regions TR has a star shape, and another one of the transparent regions TR has an irregular shape. The transparent region TR may have rectangular shape, triangular shape, circular shape, the like, or the combination thereof, not limited to those shown in figures. The number of the transparent regions TR may vary according to device requirement, for example, being in a range from 1 to 1000.

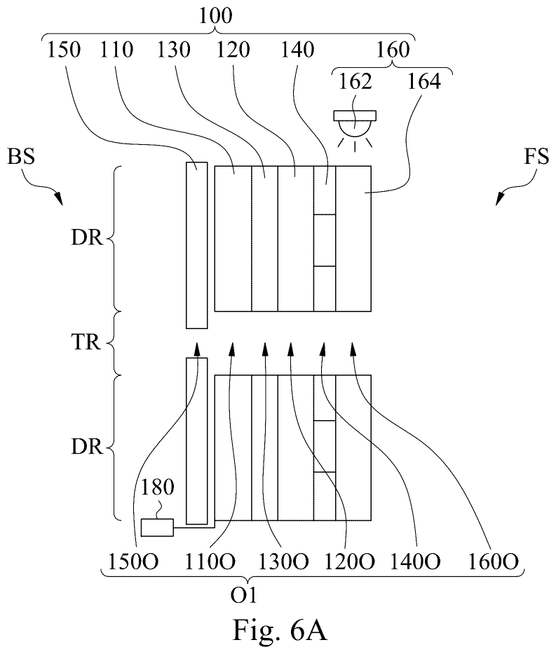

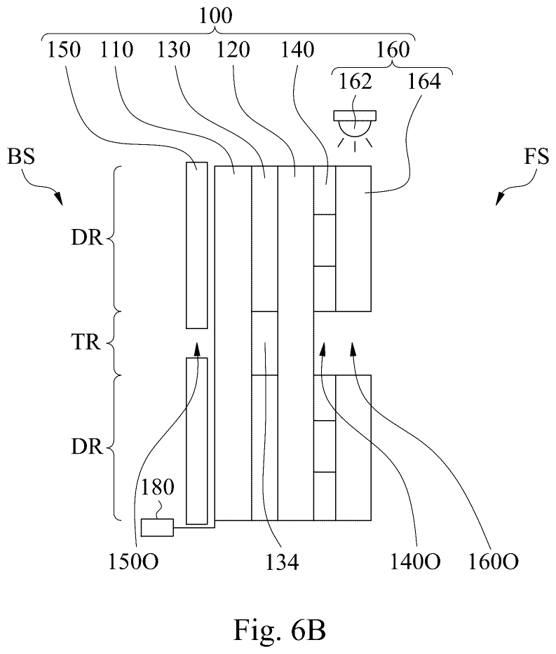

FIG. 6A is a schematic cross-sectional view of a see-through display device 100 according to some embodiment of the disclosure. The see-through display device 100 may further include a light absorbing layer 150 at the backside BS and a front-end light module 160 at the frontside FS.

The front-end light module 160 may include a light source 162 and a light guide plate 164 disposed at the frontside FS of the see-through display device 100. The light source 162 is optically coupled with the light guide plate 164. The light guide plate 164 receives the light from the light source 162 and guide the light to the display medium layer 130 uniformly.

The light absorbing layer 150 may be a film doped with dye, a substrate doped with dye, a metal layer coated with metal oxide, such as magnesium oxide (MgO), titanium dioxide (TiO₂), tantalum pentoxide (Ta₂O₅), aluminum oxide (Al₂O₃), the like, or the combination thereof. And, the light absorbing layer 150 may have a light transmittance in a range from about 0% to about 10%. The light absorbing layer 150 may prevent the user at the backside BS from being observing the reflected light at the backside BS. In some embodiments, the light absorbing layer 150 may absorb an excess portion of the light from the front-end light module 160.

In some embodiments of the present disclosure, the light absorbing layer 150 may have an opening 150O in the transparent region TR, and the light guide plate 164 have an opening 160O in the transparent region TR. The openings 150O and 160O and the openings 110O, 120O, and 130O of the first substrate 110, the second substrate 120, and the display medium layer 130, in combination, may be referred to as the opening O1 in the context. Thus, the user at the backside BS of the see-through display device 100 may see the scene on the frontside FS of the see-through display device 100 through the opening O1. The opening 150O of the light absorbing layer 150 may have a diameter less than the of the openings 110O, 120O, 130O, 140O, and 160O.

In some embodiments, the see-through display device 100 may optionally include a color filter layer 140. For example, the color filter layer 140 may include plural color filters 140R, 140G, 140B. In some embodiments, the color filter layer 140 have an opening 140O in the transparent region TR.

FIG. 6B is a schematic cross-sectional view of a see-through display device 100 according to some embodiment of the disclosure. Details of the present example are similar to the example of FIG. 6A, except that the first substrate 110, the second substrate 120, and the display medium layer 130 are intact in the transparent region TR, rather than having the openings 110O, 120O, and 130O (referring to FIG. 6A) in the transparent region TR. For example, the display medium layer 130 may have a transparent material 134 in the transparent region TR. The transparent material 134 may be made of polymer resin, glass, the like, or the combination thereof. The transparent material 134 may have a transmittance higher than about 70%. And, the first substrate 110 and the second substrate 120 may cover the entire transparent region TR. As the first substrate 110 and the second substrate 120 are substantially transparent, the user at the backside BS of the see-through display device 100 may see the scene on the frontside FS of the see-through display device 100 through the openings 140O-160O and the transparent material 134, the first substrate 110, and the second substrate 120 in the transparent region TR. One or more of the transparent material 134, the first substrate 110, and the second substrate 120 in the transparent region TR may serve as the transparent material TM in FIG. 1.

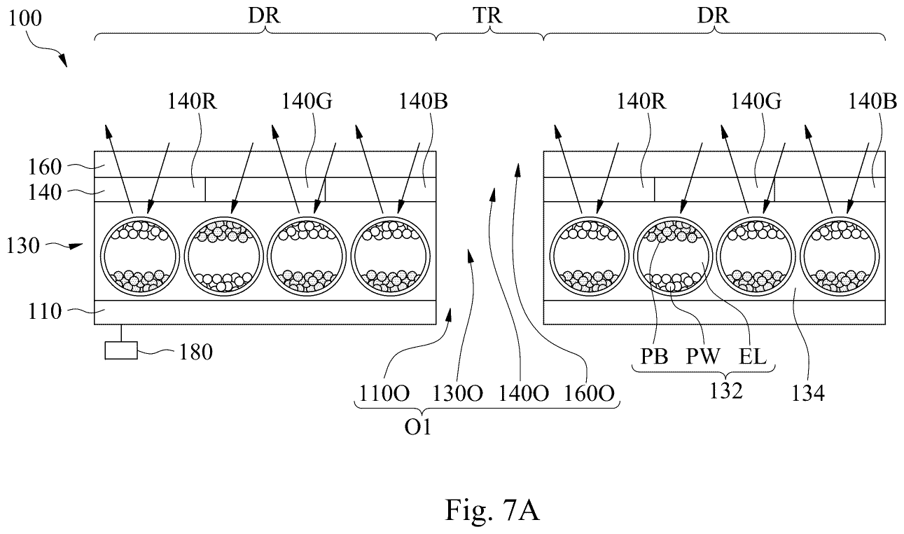

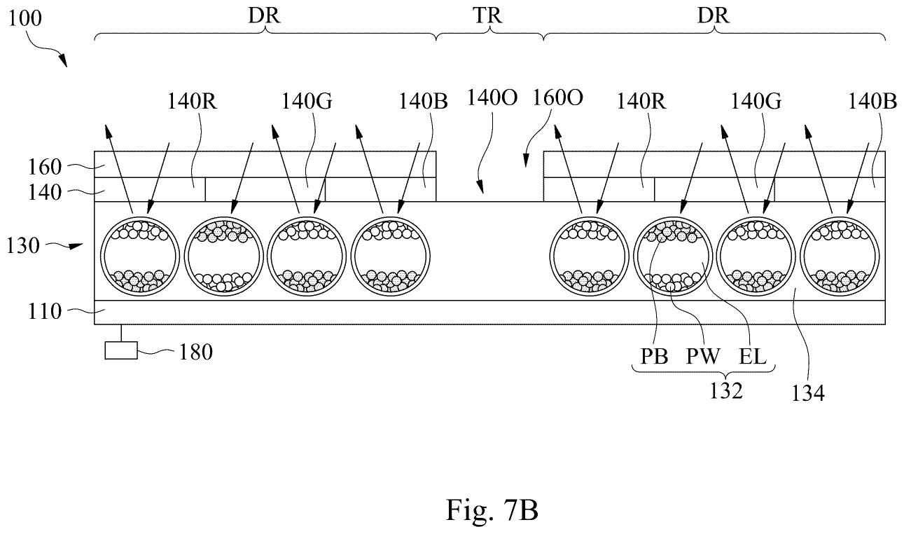

FIG. 7A is a schematic cross-sectional view illustrating an example of a see-through display device 100 according to some embodiment of the disclosure. The display medium layer 130 includes display mediums 132, which may be spaced apart from each other by the transparent material 134. In the present examples, the display mediums 132 are microcapsules disposed in the display region DR. In some other embodiments, the display mediums 132 are micro cups disposed in the display region DR. Each of the display mediums 132 may include an electrophoretic liquid EL and charged particles (e.g., the charged particles PW and PB) distributed in the electrophoretic liquid EL. With the configuration of the opening 130O, the transparent region TR of the see-through display device 100 is free of the display mediums 132 (e.g., the microcapsules), thus being free of the charged particles PW and PB, thereby achieving the see-through function of the see-through display device 100.

The charged particles in the display mediums 132 are charged pigment particles. For example, the charged particles in the display mediums 132 include white charged particles PW and black charged particles PB. The white charged particles PW and black charged particles PB may carry charges of different polarities. A movement of the black charged particles PB and the white charged particles PW may be driven by a method of adding DC voltage or AC voltage provided by the electrical controller 180, so as to display black, white or gray of different gradations. The charge on the surface attracts or repels the charged particles PB and PW in the display mediums 132 (e.g., microcapsules) to create the desired image. One or more microcapsules form a pixel of black and white images displayed on the see-through display device 100. Surely, in other embodiments that are not drawn, each of the display mediums 132 may also include the electrophoretic liquid and the white charged particles distributed in the electrophoretic liquid, wherein the electrophoretic liquid may be, for example, a black electrophoretic liquid; or, the electrophoretic liquid and the charged particles may have other colors and are not limited hereto.

FIG. 7B is a schematic cross-sectional view illustrating an example of a see-through display device 100 according to some embodiment of the disclosure. Details of the present example are similar to the example of FIG. 7A, except that the transparent material 134 of the display medium layer 130 may cover the entire transparent region TR, and the first substrate 110 may cover the entire transparent region TR. With this configuration, the transparent region TR of the see-through display device 100 is free of the charged particles PW and PB. Other details of the present example are similar to those illustrated in FIG. 7A, and therefore not repeated herein.

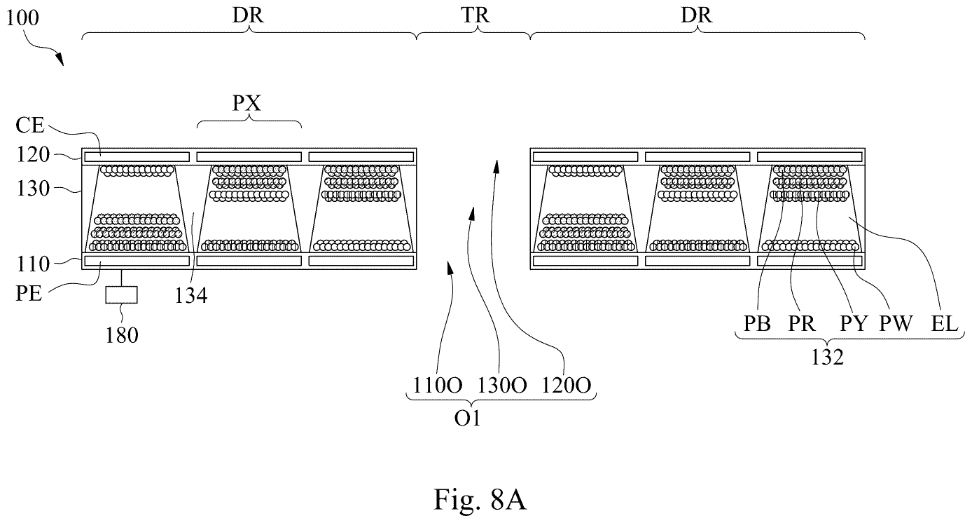

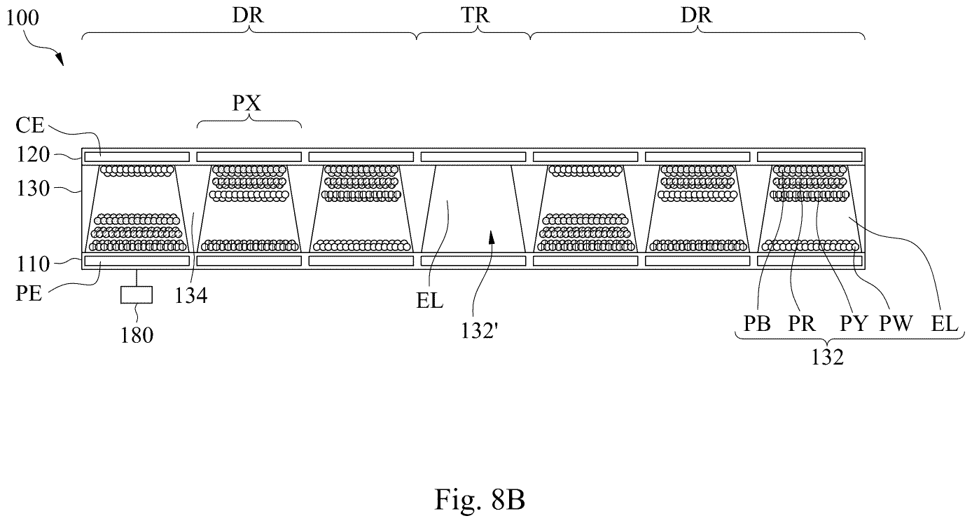

FIG. 8A is a schematic cross-sectional view illustrating an example of a see-through display device 100 according to some embodiment of the disclosure. Details of the present example are similar to the example of FIG. 7A, except that the charged particles (e.g., the charged particles PR, PB, PY, PW) distributed in the electrophoretic liquid EL may carry different amounts of charges. A movement of the charged particles PR, PB, PY, PW may be driven by a method of adding DC voltage or AC voltage provided by the electrical controller 180, so as to display various colors of different gradations. In the present example, the display mediums 132 are micro cups disposed in the display region DR, and the display mediums 132 may be spaced apart from each other by the transparent material 134. As aforementioned, with the configuration of the opening 130O, the transparent region TR of the see-through display device 100 is free of the display mediums 132 (e.g., the micro cups), thus being free of the charged particles (e.g., the charged particles PR, PB, PY, PW), thereby achieving the see-through function of the see-through display device 100.

The first substrate 110 is illustrated as having pixelated electrodes PE, and the second substrate 120 is illustrated as having counter electrodes CE. In the present embodiments, the see-through display device 100 may include pixels PX, each of the pixels PX include a display medium 132 (e.g., a micro cup), a pixelated electrode PE, and a counter electrode CE, in which the DC voltage or AC voltage can be added by applying voltages on the pixelated electrode PX and the counter electrode CE forming pixelated images. Other details of the present example are similar to those illustrated above, and thereto not repeated herein.

FIG. 8B is a schematic cross-sectional view illustrating an example of a see-through display device 100 according to some embodiment of the disclosure. Details of the present example are similar to the example of FIG. 8A, except that the display medium layer 130 has one or more dummy display mediums 132′ (e.g., the micro cups) free of the charged particles (e.g., the charged particles PR, PB, PY, PW) in the transparent region TR. The dummy display medium 132′ (e.g., the micro cups) may be filled with the electrophoretic liquid EL. The display mediums 132 and the dummy display medium 132′ may be spaced apart from each other by the transparent material 134. Other details of the present example are similar to those illustrated above, and thereto not repeated herein.

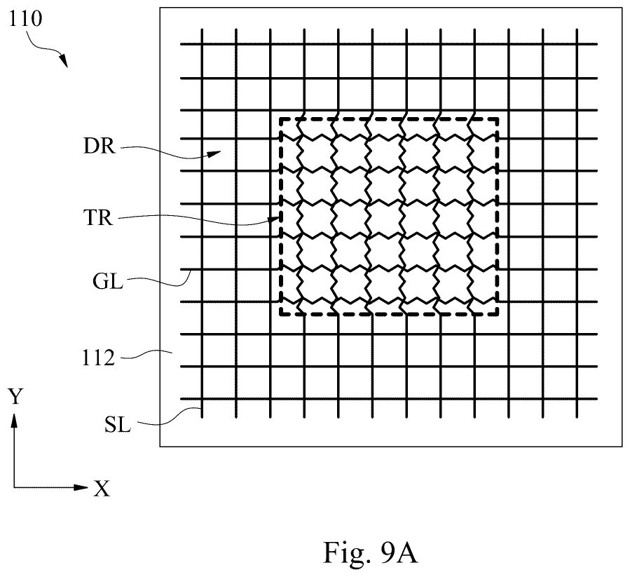

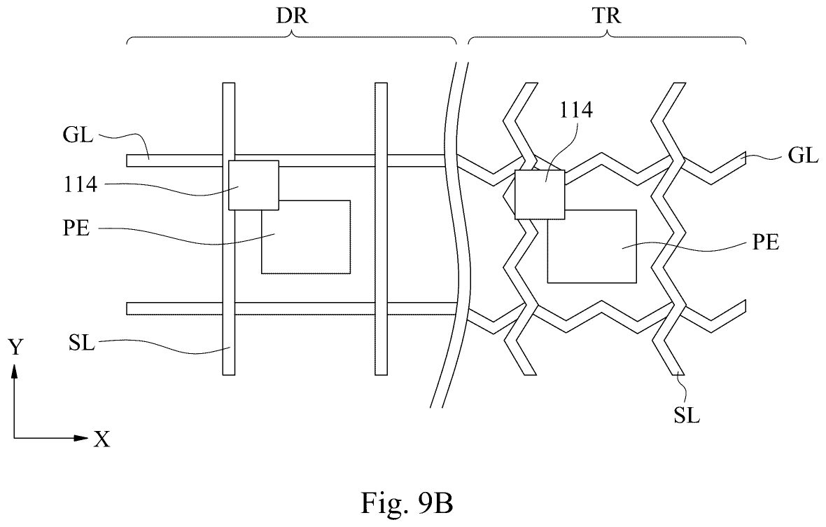

FIG. 9A is a schematic top view of an active device array substrate 110 of a see-through display device according to some embodiment of the disclosure. FIG. 9B is an enlarged view of a portion of the active device array substrate 110 of FIG. 9A. The active device array substrate 110 includes a substrate 112, plural data lines SL, plural gate lines GL, plural active devices 114, and pixelated electrodes PE over the substrate 112. The data lines SL may extend along a direction Y, and the gate lines GL may extend along a direction X intersecting the direction Y. For example, the direction X is orthogonal to the second direction. The pixelated electrodes PE are electrically connected with the data lines SL through the active devices 114. For example, each of the active devices 114 has a first terminal electrically connected with one of the pixelated electrodes PE, a second terminal electrically connected with one of the data lines SL, and a control terminal electrically connected with one of the gate lines GL.

In some embodiments, shapes of the data lines SL and the gate lines GL in the transparent region TR of the see-through display device 100 are respectively different from shapes of the data lines SL and the gate lines GL in the display region DR of the see-through display device 100. For example, the data lines SL and the gate lines GL in the display region DR of the see-through display device 100 are straight lines, and the data lines SL and the gate lines GL in the transparent region TR of the see-through display device 100 are not straight lines, but having a sawtooth shape. With the configuration, the diffractions derive from the pattern of the metal lines or the black matrix can be reduced, thereby reducing the influence of the diffractions on the see-through viewing performance.

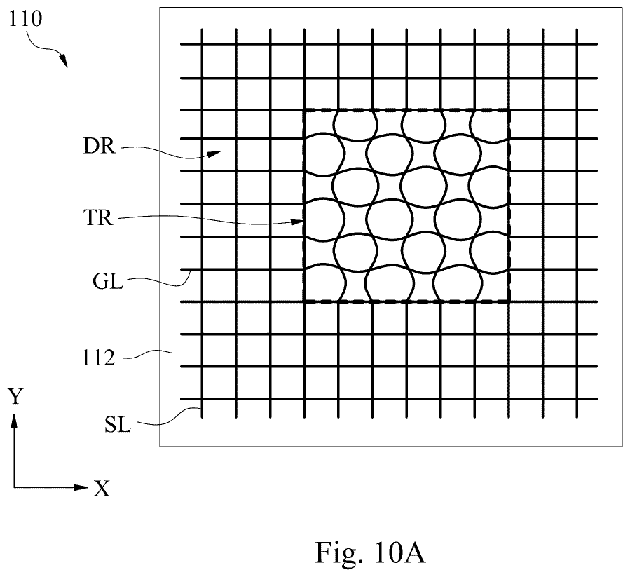

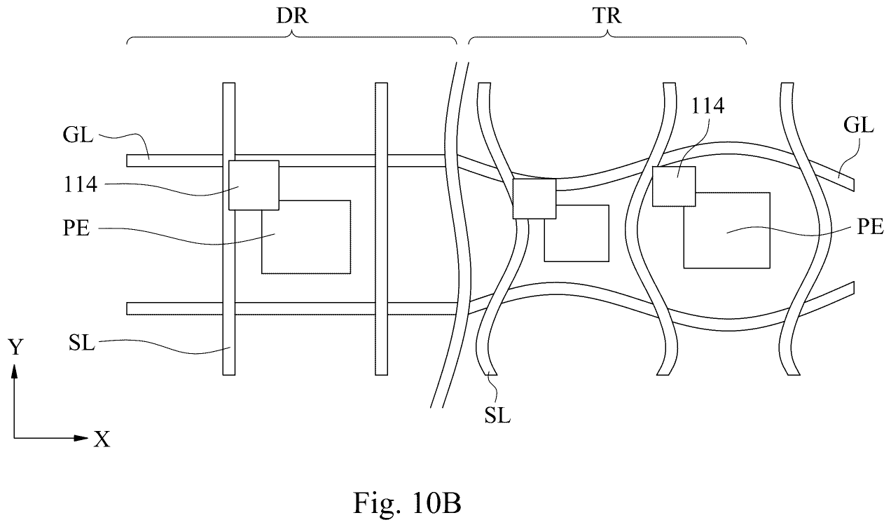

FIG. 10A is a schematic top view of an active device array substrate 110 of a see-through display device according to some embodiment of the disclosure. FIG. 10B is an enlarged view of a portion of the active device array substrate 110 of FIG. 10A. Details of the present embodiments are similar to those illustrated in the embodiments of FIGS. 9A and 9B, except that the data lines SL and the gate lines GL in the transparent region TR of the see-through display device 100 have a curved shape. Other details of the present embodiments are similar to those illustrated in embodiments of FIGS. 9A and 9B, therefore not repeated herein.

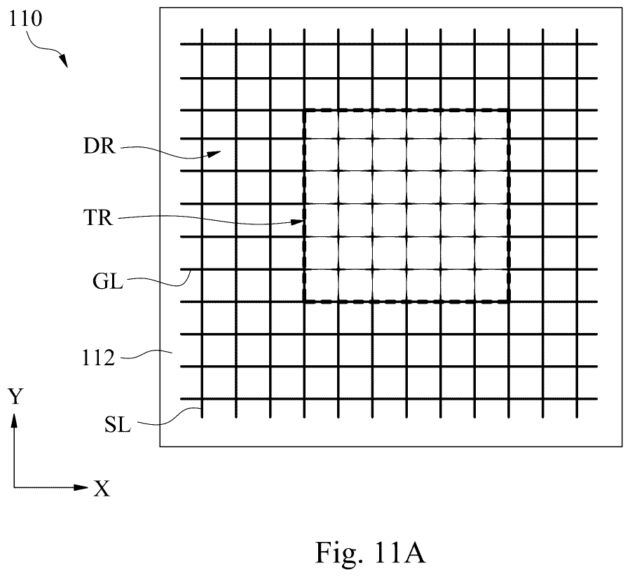

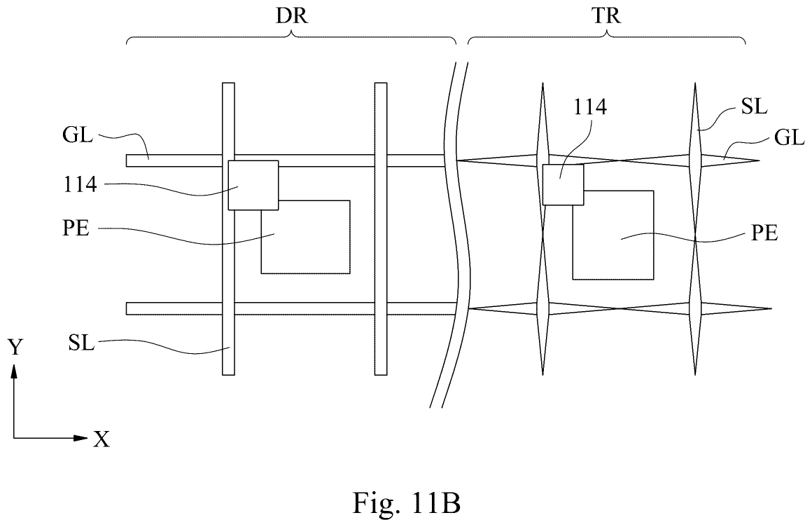

FIG. 11A is a schematic top view of an active device array substrate of a see-through display device according to some embodiment of the disclosure. FIG. 11B is an enlarged view of a portion of the active device array substrate of FIG. 11A. Details of the present embodiments are similar to those illustrated in the embodiments of FIGS. 9A and 9B, except that the gate lines GL in the transparent region TR of the see-through display device 100 have a width variation in their extending direction X, and the data lines SL in the transparent region TR of the see-through display device 100 have a width variation in their extending direction Y. The data lines SL and the gate lines GL in the display region DR of the see-through display device 100 may have uniform widths, different from those in the transparent region TR of the see-through display device 100. Other details of the present embodiments are similar to those illustrated in embodiments of FIGS. 9A and 9B, therefore not repeated herein.

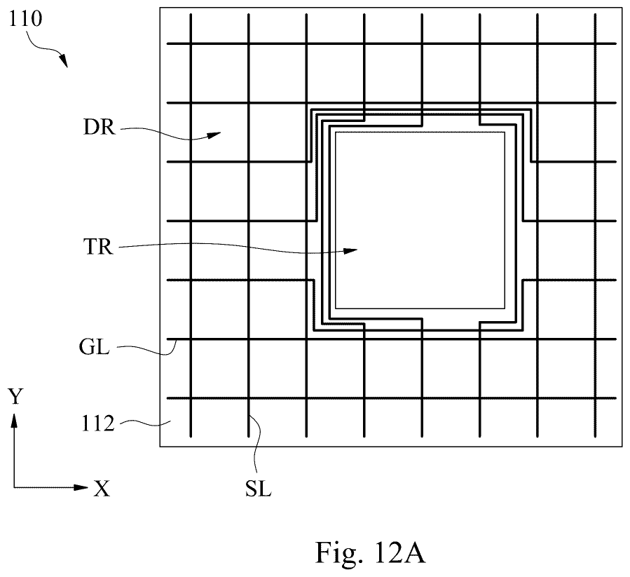

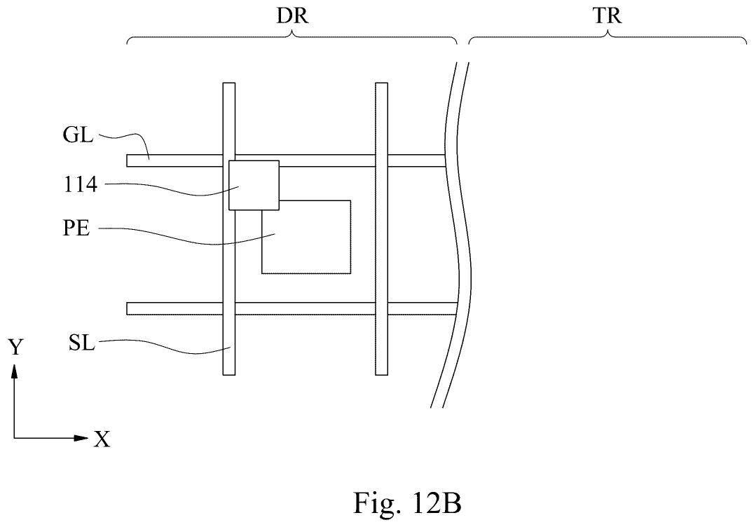

FIG. 12A is a schematic top view of an active device array substrate of a see-through display device according to some embodiment of the disclosure. FIG. 12B is an enlarged view of a portion of the active device array substrate of FIG. 12A. Details of the present embodiments are similar to those illustrated in the embodiments of FIGS. 9A and 9B, except that the gate lines GL and the data lines SL are absent from the transparent region TR of the see-through display device 100. For example, the gate lines GL and the data lines SL are diverted away from the transparent region TR. And, active devices 114 and pixelated electrodes PE are absent from the transparent region TR. Other details of the present embodiments are similar to those illustrated in embodiments of FIGS. 9A and 9B, and therefore not repeated herein.

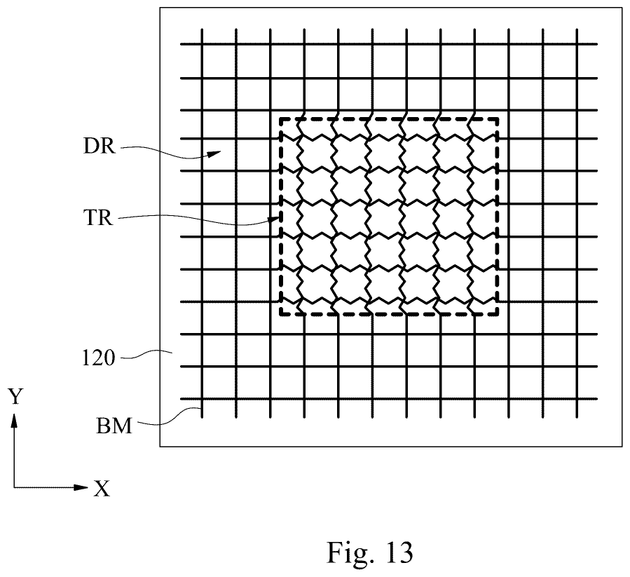

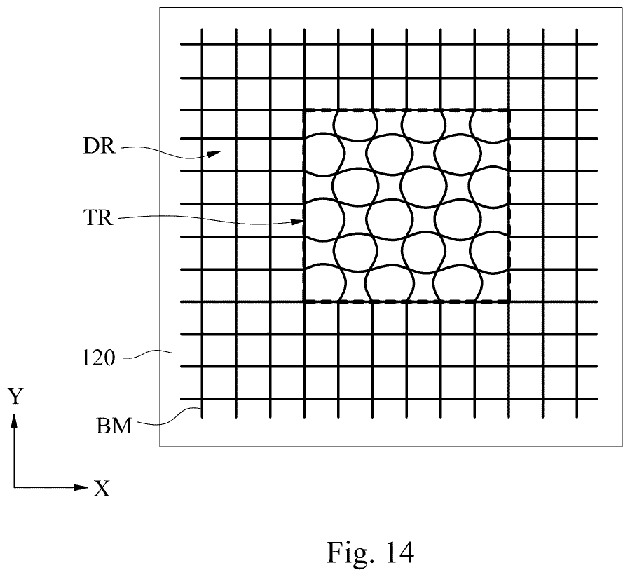

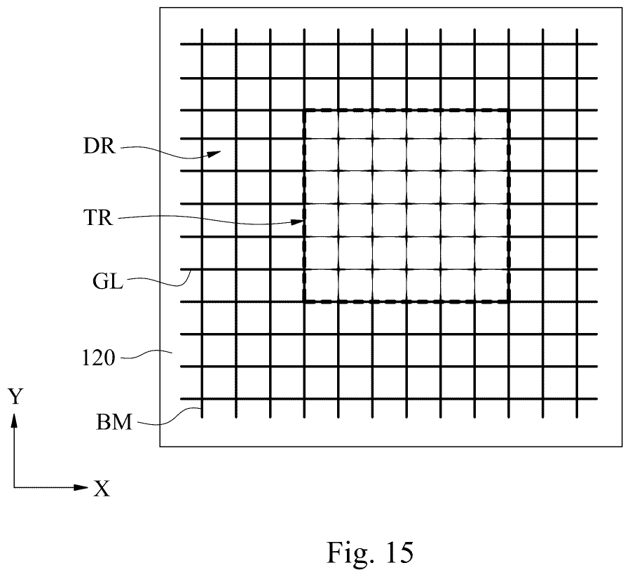

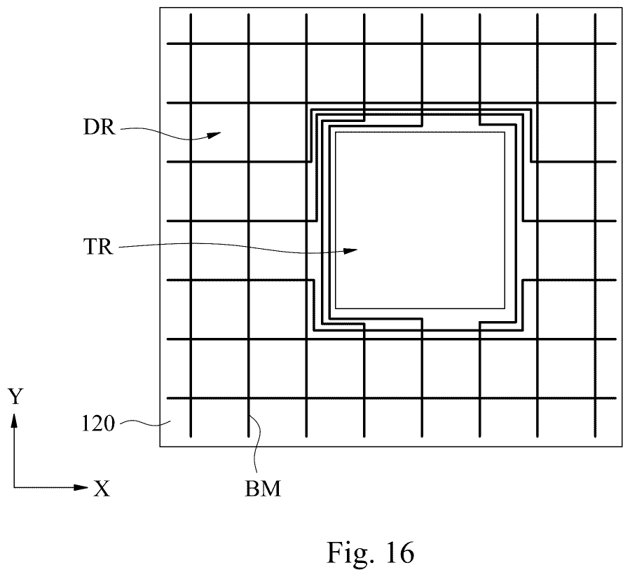

FIGS. 13-16 respectively show schematic top views of black matrixes BM of see-through display devices according to some embodiment of the disclosure. The black matrixes BM can be formed over the substrate 112 of the active device array substrate 110 or the second substrate 120. The black matrix BM may have lines for blocking lights, and the lines of the black matrix BM form openings to allow the light passing the black matrixes BM, in which the openings of the black matrix BM may be disposed corresponding to the pixelated electrodes PE. The black matrix BM may have patterns similar to the patterns of the gate lines GL and the data lines SL in FIGS. 9A, 10A, 11A, and 12A. For example, in FIG. 13, the lines of the black matrix BM in the display region DR of the see-through display device 100 are straight lines, and the lines of the black matrix BM in the transparent region TR of the see-through display device 100 are not straight lines, but having a sawtooth shape. In FIG. 14, the lines of the black matrix BM in the transparent region TR of the see-through display device 100 have a curved shape. In FIG. 15, the lines of the black matrix BM in the transparent region TR have width variation in their extending direction, and the lines of the black matrix BM in the display region DR have uniform widths. In FIG. 16, the lines of the black matrix BM are absent from the transparent region TR. For example, the lines of the black matrix BM are diverted away from the transparent region TR. Other details of the present embodiments are similar to those illustrated above, and therefore not repeated herein.

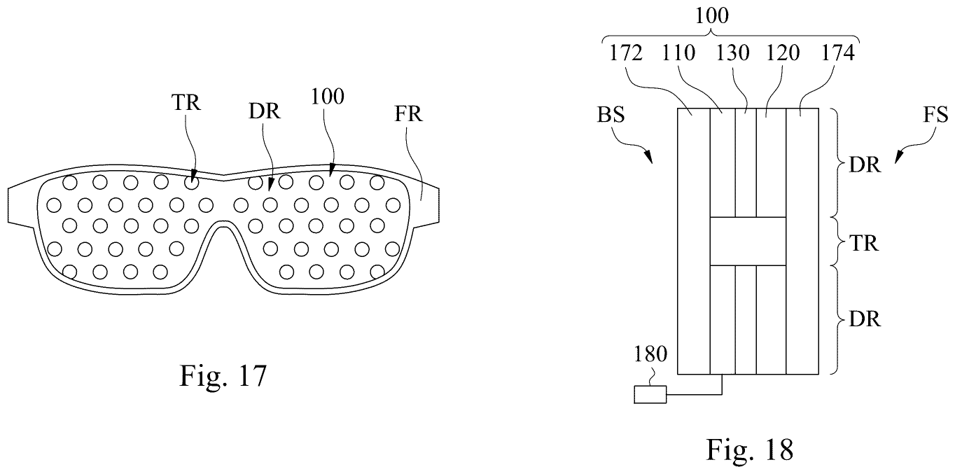

FIG. 17 is a front-side view of an exemplary see-through display device 100 according to some embodiment of the disclosure. FIG. 18 is a schematic cross-sectional view of the see-through display device of FIG. 17. Reference is made to both FIGS. 17 and 18. The see-through display device 100 is mounted on a frame FR to form a pair of eyeglasses. In some embodiments, the see-through display device 100 may further include a backside protective layer 172 at the backside BS of the see-through display device 100 and a frontside protective layer 174 at the frontside FS of the see-through display device 100. The backside and frontside protective layers 172 and 174 may protect the see-through display device 100 from dusts. In some embodiments, the backside protective layer 172 includes an anti-reflection film having a reflectance less than about 15%, such that the user U1 at the backside BS can clearly observe the scene on the frontside FS of the see-through display device 100. Other details of the present embodiments are similar to those illustrated in embodiments of FIGS. 9A and 9B, and therefore not repeated herein.

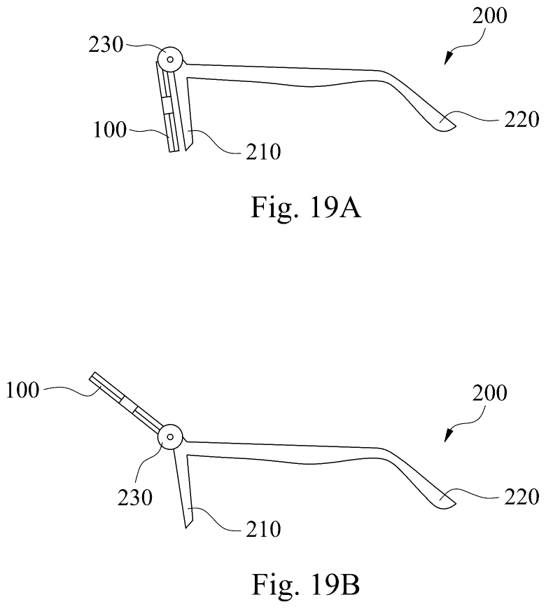

FIGS. 19A and 19B are lateral-side views of an exemplary see-through display device according to some embodiment of the disclosure. The see-through display device 100 is mounted on a pair of eyeglasses 200. The pair of eyeglasses 200 may include a front 210 and two temples 220. The front 210 is configured for holding lens, such convex lens or concave lens. In some embodiments, the pair of eyeglasses 200 may include a pivot connector 230 configured to pivotally connect the see-through display device 100 to the front 210. With this configuration, a user wearing the pair of eyeglasses 200 may choose to see through the see-through display device 100 or not by rotating the see-through display device 100 with respect to the front 210 (e.g., lifting down and up the see-through display device 100). Other details of the present embodiments are similar to those illustrated above, and therefore not repeated herein.

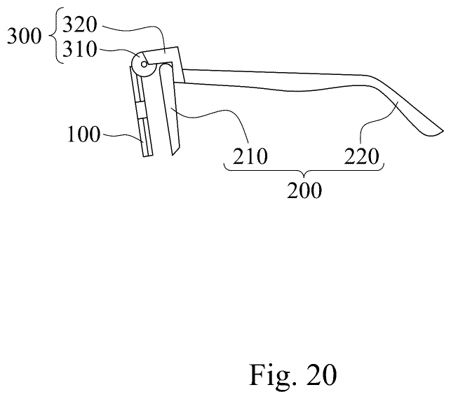

FIG. 20 is a lateral-side view of an exemplary see-through display device according to some embodiment of the disclosure. The see-through display device 100 is detachably mounted on a pair of eyeglasses 200, for example, through an auxiliary element 300. The auxiliary element 300 may include a pivot connector 310 and a fixing element 320. The pivot connector 310 is configured to pivotally connect the see-through display device 100 to the fixing element 320. And, the fixing element 320 is configured to be detachably mounted on the pair of eyeglasses 200 (e.g., the temples 220). Other details of the present embodiments are similar to those illustrated above, and therefore not repeated herein.

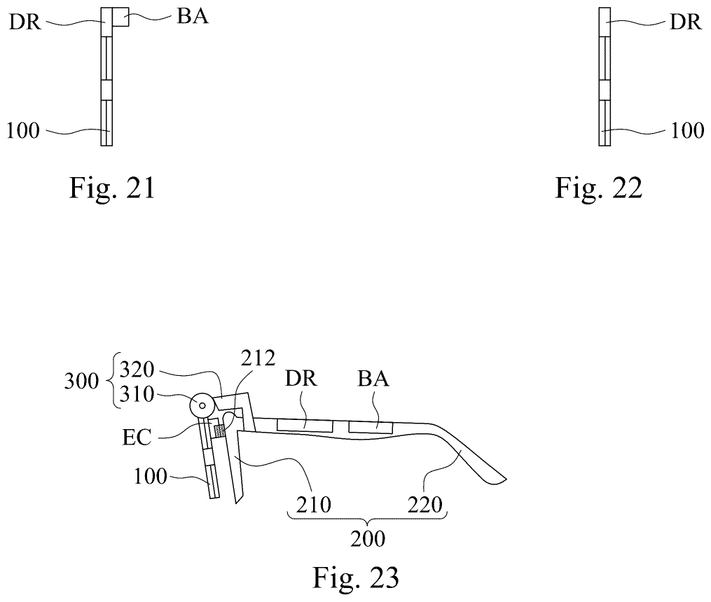

FIG. 21 is a lateral-side view of an exemplary see-through display device 100 according to some embodiment of the disclosure. In the present embodiments, the see-through display device 100 is equipped with a driver DR and a power source (e.g., battery) BA. The power source (e.g., battery) BA is configured to provide electrical power to the driver DR and the display medium layer 130, either by wireless charging or by wired charging. The driver DR may include a microcontroller, which may perform data compression, image compensation, and rendering. The driver DR provide signals to the data lines and the gate lines based on a command regarding the target image, thereby forming a target image by the display medium layer 130. The driver DR may receive the command regarding a target image, either by wireless transmission or by wired transmission. In some embodiments, the driver DR may include a wireless transceiver configured to receive the command regarding a target image from a user device (e.g., an application of a mobile phone). The application of the mobile phone may perform color image processing and data compression. With the configuration, the see-through display device 100 can change the image provided by the display medium layer 130 when the user wears the see-through display device 100. Other details of the present embodiments are similar to those illustrated above, and therefore not repeated herein.

FIG. 22 is a lateral-side view of an exemplary see-through display device 100 according to some embodiment of the disclosure. Details of the present embodiments are similar to those of FIG. 21, except that the see-through display device 100 is free of the power source BA (referring to FIG. 21). Through the configuration, the see-through display device 100 may keep the same image when the user wears the see-through display device 100, and may change the image provided by the display medium layer 130 when the see-through display device 100 is electrically connected to an external power source. Other details of the present embodiments are similar to those illustrated above, and therefore not repeated herein.

FIG. 23 is a lateral-side view of an exemplary see-through display device 100 according to some embodiment of the disclosure. Details of the present embodiments are similar to those of FIG. 20, except that the driver DR and the power source BA are embedded in the temples 220 of the pair of eyeglasses 200, and the see-through display device 100 may be electrically connected with the driver DR and the power source BA. For example, the see-through display device 100 has a chip EC for transmitting signals and supplying powers, and the chip EC has a contact region with plural electrical contacts. And, the front 210 has a contact region with electrical contacts 212. The front 210 may include metal lines/circuits embedded therein, which may connect the electrical contacts 212 to the driver DR and the power source BA for transmitting signals and supplying powers. When the see-through display device 100 is lifted down, the electrical contacts of chip EC may be in contact with the electrical contacts 212 of the front 210, such that the signals and powers from the driver DR and the power source BA may be sent to the see-through display device 100. In some embodiments, the contact region of the chip EC and the contact region of the front 210 may be designed with slots for fixing and positioning. In some embodiments, the contact region of the chip EC and the contact region of the front 210 may be designed with magnetic elements for contacting and positioning by magnetic attraction force. Other details of the present embodiments are similar to those illustrated above, and therefore not repeated herein.

In some embodiments of the present disclosure, a see-through display device is designed with transparent regions, such that a user at the backside of the see-through display device may see the scene on a frontside of the see-through display device through the transparent regions. And, the observer at the frontside of the see-through display device may perceive the image displayed by the see-through display device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A see-through display device, having a transparent region and a display region surrounding the transparent region, and the see-through display device comprising:
a first substrate coated with a plurality of pixelated electrodes;
a second substrate coated with a counter electrode;
a display medium layer between the first substrate and the second substrate, wherein the display medium layer in the transparent region is transparent; and
an electrical controller, electrically connected to the first substrate and the second substrate to provide signals to the pixelated electrodes and the counter electrode.

2. The see-through display device of claim 1, wherein the display medium layer comprises a plurality of display mediums in the display region, each of the plurality of display mediums comprises an electrophoretic liquid and a plurality of charged particles distributed in the electrophoretic liquid, and the transparent region of the see-through display device is free of the charged particles.

3. The see-through display device of claim 1, wherein the display medium layer comprises a cholesteric liquid crystal material, and the transparent region of the see-through display device is free of the cholesteric liquid crystal material.

4. The see-through display device of claim 1, wherein the display medium layer has an opening in the transparent region of the see-through display device.

5. The see-through display device of claim 4, wherein the first substrate has a first opening in the transparent region of the see-through display device, and the second substrate has a second opening in the transparent region of the see-through display device.

6. The see-through display device of claim 1, wherein the display medium layer has a transparent material in the transparent region of the see-through display device.

7. The see-through display device of claim 1, further comprising:
a plurality of active devices over the first substrate and electrically connected with the pixelated electrodes;
a plurality of data lines over the first substrate and electrically connected with terminals of the active devices; and
a plurality of gate lines over the first substrate and electrically connected with control terminals of the active devices, wherein the transparent region of the see-through display device is free of the data lines and the gate lines.

8. The see-through display device of claim 1, further comprising:
a plurality of active devices over the first substrate and electrically connected with the pixelated electrodes; and
a plurality of data lines over the first substrate and electrically connected with terminals of the active devices, wherein a shape of the data lines in the transparent region of the see-through display device is different from a shape of the data lines in the display region of the see-through display device.

9. The see-through display device of claim 8, further comprising:
a plurality of gate lines over the first substrate and electrically connected with control terminals of the active devices, wherein a shape of the gate lines in the transparent region of the see-through display device is different from a shape of the gate lines in the display region of the see-through display device.

10. The see-through display device of claim 1, further comprising:
a light absorbing layer, wherein the first substrate is between the light absorbing layer and the display medium layer; and
a front-end light module, wherein the second substrate is between the front-end light module and the display medium layer.

11. The see-through display device of claim 1, further comprising:
a backside protective layer, wherein the first substrate is between the backside protective layer and the display medium layer; and
a frontside protective layer, wherein the second substrate is between the frontside protective layer and the display medium layer.

12. The see-through display device of claim 11, wherein the backside protective layer comprises an anti-reflection film having a reflectance less than 15%.

13. A see-through display device, having a transparent region and a display region surrounding the transparent region, and the see-through display device comprising:
an active device array substrate, comprising:
a first substrate;
a plurality of pixelated electrodes over the first substrate;
a plurality of active devices over the first substrate and electrically connected with the pixelated electrodes; and
a plurality of data lines over the first substrate and electrically connected with terminals of the active devices, wherein a shape of the data lines in the transparent region of the see-through display device is different from a shape of the data lines in the display region of the see-through display device;
a second substrate coated with a counter electrode; and
a display medium layer between the active device array substrate and the second substrate.

14. The see-through display device of claim 13, wherein the display medium layer comprises a plurality of display mediums in the display region, each of the plurality of display mediums comprises an electrophoretic liquid and a plurality of charged particles distributed in the electrophoretic liquid, and the transparent region of the see-through display device is free of the charged particles.

15. The see-through display device of claim 13, wherein the display medium layer comprises a cholesteric liquid crystal material, and the transparent region of the see-through display device is free of the cholesteric liquid crystal material.

16. The see-through display device of claim 13, wherein the active device array substrate further comprises:
a plurality of gate lines over the first substrate and electrically connected with control terminals of the active devices, wherein a shape of the gate lines in the transparent region of the see-through display device is different from a shape of the gate lines in the display region of the see-through display device.

17. The see-through display device of claim 13, wherein the shape of the data lines in the transparent region of the see-through display device is a sawtooth shape.
